(19) United States
(12) Patent Application Publication
(10) Pub. No.: US 2013/0005530 A1
(43) Pub. Date: Jan. 3, 2013

(54) VEHICULAR HYBRID DRIVE SYSTEM

(75) Inventors: Masato Fujikawa, Toyota-shi (JP); Tomoyuki Maruyama, Tajimi-shi (JP)

(73) Assignee: TOYOTA JIDOSHA KABUSHIKI KAISHA, Toyota-shi (JP)

(21) Appl. No.: 13/583,734

(22) PCT Filed: Mar. 10, 2010
(86) PCT No.: PCT/JP2010/054059

§ 371 Date: Sep. 10, 2012

(51) Int. Cl. B60W 10/08

(52) U.S. Cl. 477/5; 180/65.265; 903/902

(57) ABSTRACT

A motor drive mode for driving a vehicle with only a second motor/generator is available in a selected one of two motor drive sub-modes consisting of a response-oriented motor drive sub-mode established by placing a forward drive clutch in a released state and placing a starting clutch in an engaged state, and a fuel-economy-oriented motor drive sub-mode established by placing the forward drive clutch in an engaged state and placing the starting clutch in a released state. In the response-oriented motor drive sub-mode in which an engine and a transmission are disconnected from each other, the engine can be efficiently started to change the vehicle drive mode to an engine drive mode, and an engaging action of only the forward drive clutch is required after starting of the engine, so that the engine drive mode can be established with a high response. In the fuel-economy-oriented motor drive sub-mode, the starting clutch is released to disconnect the transmission from the motor/generator, for reducing a power loss and improving fuel economy. After starting of the engine to establish the engine drive mode, an engaging action of only the starting clutch is required.

### TECHNICAL FIELD

The present invention relates to a vehicular hybrid drive system, and more particularly to techniques for improving a response of the hybrid drive system to a change from a motor drive mode to an engine drive mode.

### BACKGROUND ART

There is known a hybrid drive system of a vehicle, including (a) an engine, (b) a first electric motor connected to the engine, (c) a first connecting/disconnecting device configured to permit and inhibit power transmission between the above-described engine and the above-described first electric motor, and drive wheels of the vehicle, (d) a second connecting/disconnecting device configured to permit and inhibit power transmission between the first connecting/disconnecting device and the above-described drive wheels, and (e) a second electric motor enabling the vehicle to run while the above-described engine is at rest, and (f) the hybrid drive system permitting the vehicle to run in a motor drive mode with an operation of the above-described second electric motor while the engine is at rest, and in an engine drive mode with an operation of the engine. Patent Document 1 discloses one example of such a hybrid drive system, which is provided with a forward/reverse switching device as the first connecting/disconnecting device, and a belt type continuously variable transmission disposed in a power transmitting path between the forward/reverse switching device and the second connecting/disconnecting device, and wherein the second electric motor is connected between the second connecting/disconnecting device and the drive wheels. In the motor drive mode in which the vehicle is driven with the second electric motor operated as a vehicle drive power source, the second connecting/disconnecting device located closest to the second electric motor is brought into a power cut-off state to reduce a power loss due to dragging rotary motions of the continuously variable transmission or the like.

### PRIOR ART DOCUMENT

### Patent Document

Patent Document 1: JP-2005-59787A

### SUMMARY OF THE INVENTION

### Object Achieved By The Invention

By the way, the vehicular hybrid drive system as described above requires cranking of the engine by the first electric motor to start the engine upon changing of a vehicle drive mode from the above-indicated motor drive mode to the engine drive mode. If the first connecting/disconnecting device and the second connecting/disconnecting device are both placed in the power cut-off state, both of the first and second connecting/disconnecting devices must be brought into their power transmitting states after starting of the engine, with a need of complicated controls for connecting (such as including hydraulic controls) which may cause a shock or take a lot of time, resulting in deterioration of a response. If the first connecting/disconnecting device is brought into the power transmitting state in advance while the motor drive mode is established, only the second connecting/disconnecting device is required to be brought into the power transmitting state after starting of the engine, so that the control can be implemented more simply and efficiently. However, the cranking of the engine while the first connecting/disconnecting device is in the power transmitting state makes it difficult to start the engine due to an inertia of the transmission, etc., leading to deterioration of the response before an output of the engine is obtained, so that the cranking of the engine under the above-indicated condition is not sufficiently satisfactory. A slow starting of the engine tends to make a vehicle operator feel a low response of the engine, in a power drive mode in which the vehicle operator expects a high response of the vehicle drive force to a vehicle accelerating operation, for example.

The present invention was made in view of the background art described above. It is therefore an object of the present invention to improve the response to a change from the motor drive mode for driving the vehicle with an operation of the second electric motor while the engine is at rest, to the engine drive mode for driving the vehicle with an operation of the engine.

### Means for Achieving the Object

The object indicated above is achieved according to a first aspect of the present invention, which provides a hybrid drive system of a vehicle, including (a) an engine, (b) a first electric motor connected to the engine, (c) a first connecting/disconnecting device configured to permit and inhibit power transmission between the above-described engine and the above-described first electric motor, and drive wheels of the vehicle, (d) a second connecting/disconnecting device configured to permit and inhibit power transmission between the above-described first connecting/disconnecting device and the above-described drive wheels, and (e) a second electric motor enabling the vehicle to run while the above-described engine is at rest, and (f) the hybrid drive system permitting the vehicle to run in a motor drive mode with an operation of the above-described second electric motor while the above-described engine is at rest, and in an engine drive mode with an operation of the engine, characterized in that (g) the above-described first connecting/disconnecting device is placed in a power cut-off state while the above-described second connecting/disconnecting device is placed in a power transmitting state, in the above-described motor drive mode.

According to a second aspect of the present invention, the above-described motor drive mode in the hybrid drive system according to the first aspect of the invention is available in a selected one of two motor drive sub-modes consisting of a response-oriented motor drive sub-mode established by placing the above-described first connecting/disconnecting device in the power cut-off state and placing the above-described second connecting/disconnecting device in the power transmitting state, and a fuel-economy-oriented motor drive sub-mode established by placing the first connecting/disconnecting device in a power transmitting state and placing the second connecting/disconnecting device in a power cut-off state.

According to a third aspect of the present invention, the hybrid drive system according to the first or second aspect of the invention is provided with a transmission disposed in a power transmitting path between the above-described first connecting/disconnecting device and the above-described second connecting/disconnecting device.

According to a fourth aspect of the present invention, the above-described second connecting/disconnecting device in the hybrid drive system according to the first or second aspect of the invention is a transmission which is switchable between a power transmitting state for permitting the power transmission with a predetermined speed ratio, and a power cut-off state for inhibiting the power transmission with the predetermined speed ratio.

### Advantages of the Invention

In the vehicular hybrid drive system described above, the first connecting/disconnecting device is placed in the power cut-off state while the second connecting/disconnecting device is placed in the power transmitting state, in the motor drive mode, so that the engine can be efficiently started by cranking by the first electric motor to change the vehicle drive mode from the motor drive mode to the engine drive mode by starting the engine. After the engine has been started, an engaging action of only the first connecting/disconnecting device is required, and a control for this engaging action can be implemented easily and efficiently. Accordingly, the response to a vehicle accelerating operation by a vehicle operator is improved, permitting the engine to provide a comparatively large vehicle drive force in an efficient manner upon changing of the vehicle drive mode from the motor drive mode to the engine drive mode. Thus, the vehicle operator who desires a powerful driving of the vehicle with a high response to the vehicle accelerating operation in a power drive mode, for example, can be satisfied to an increased extent with the vehicle running in the power drive mode.

According to the second aspect of the invention, the motor drive mode is available in the selected one of the response-oriented motor drive sub-mode established by placing the above-described first connecting/disconnecting device in the power cut-off state and placing the above-described second connecting/disconnecting device in the power transmitting state, and the fuel-economy-oriented motor drive sub-mode established by placing the first connecting/disconnecting device in the power transmitting state and placing the second connecting/disconnecting device in the power cut-off state. For example, the motor drive mode is switched between the response-oriented motor drive sub-mode and the fuel-economy-oriented motor drive sub-mode, depending upon a manner of driving of the vehicle desired by an operator of the vehicle, a running speed of the vehicle, an SOC (state of charge) (electric energy amount stored in an electric-energy storage device) or any other condition of the vehicle, so that it is possible to prevent deterioration of the fuel economy of the vehicle, while assuring an improvement of the response upon changing of the vehicle drive mode from the motor drive mode to the engine drive mode. In the fuel-economy-oriented motor drive sub-mode in which the second connecting/disconnecting device located close to the drive wheels is placed in the power cut-off state, the number of rotary members having dragging rotary motions in this motor drive sub-mode is reduced, with a result of reduction of the power loss (reduction of a load acting on the electric motor) and an improvement of the fuel economy of the vehicle.

According to the third aspect of the invention in which the transmission is disposed in the power transmitting path between the first connecting/disconnecting device and the second connecting/disconnecting device, the first connecting/disconnecting device is placed in the power cut-off state to disconnect the transmission from the engine in the motor drive mode, for considerably reducing an inertia upon cranking of the engine by the first electric motor, making it possible to considerably improve the ease of starting of the engine, and considerably improve the vehicle response upon changing of the vehicle drive mode from the motor drive mode to the engine drive mode.

According to the fourth aspect of the invention, the second connecting/disconnecting device is the transmission switchable between the power transmitting state for permitting the power transmission with the predetermined speed ratio and the power cut-off state for inhibiting the power transmission. In this hybrid drive system, too, the first connecting/disconnecting device is placed in the power cut-off state to disconnect the transmission from the engine in the motor drive mode, for considerably reducing an inertia upon cranking of the engine by the first electric motor, making it possible to considerably improve the ease of starting of the engine, and considerably improve the vehicle response upon changing of the vehicle drive mode from the motor drive mode to the engine drive mode.

### BRIEF DESCRIPTION OF THE DRAWINGS

FIG. 1 is a schematic view showing an arrangement of a hybrid drive system of a vehicle according to one embodiment of this invention, together with a control system for switching between a motor drive mode and an engine drive mode;

FIG. 2 is a schematic view showing an example of a forward/reverse switching device of FIG. 1;

FIG. 3 is a view indicating an example of a vehicle drive power source switching map to be used for a vehicle drive power source switching control for switching between the engine drive mode and the motor drive mode;

FIG. 4 is a view for explaining engaged and released states of a forward drive clutch and a starting clutch in the motor drive mode and the engine drive mode;

FIG. 5 is a flow chart illustrating in detail an operation of motor drive switching means of FIG. 1;

FIG. 6 is a flow chart illustrating an operation of motor drive switching means of FIG. 1 according to another embodiment of the invention;

FIG. 7 is a flow chart illustrating an operation of motor drive switching means of FIG. 1 according to a further embodiment of the invention;

FIG. 8 is a schematic view showing another arrangement of a vehicular hybrid drive system to which the present invention is preferably applicable;

FIG. 9 is a view for explaining the engaged and released states of the forward drive clutch and starting clutch in the motor drive mode and engine drive mode in the vehicular hybrid drive system of FIG. 8;

FIG. 10 is a view showing an example of a shift pattern in the embodiment of FIG. 1; and

FIG. 11 is a flow chart illustrating an example of an operation for switching between a response-oriented drive mode and a fuel-economy-oriented drive mode, depending upon whether a sequential mode is selected or not, where the shift pattern of FIG. 10 is available.

### MODE FOR CARRYING OUT THE INVENTION

The above-described engine may be an internal combustion engine constructed to produce a drive force by combustion of a fuel, while each of the above-described first and second electric motors may be an electric motor constructed to produce a drive force with electrical energy, or a motor/generator which can be used as an electric motor and an electric generator. The first electric motor may be disposed coaxially with the engine and integrally connected to its crankshaft, for instance, or may be connected to the engine through a synthesizing/distributing mechanism such as a planetary gear device, or through a transmission constructed to change its speed ratio to increase or reduce. Various other arrangements are available for connecting the first electric motor to the engine. While the second electric motor is connected to a power transmitting path between the second connecting/disconnecting device and the vehicle drive wheels, the second electric motor may be connected to the engine, first electric motor or first connecting/disconnecting device, or may be disposed to rotate vehicle drive wheels that are different from the vehicle drive wheels to which the second connecting/disconnecting device is connected.

Each of the first and second connecting/disconnecting devices may be a simple clutch, or may be constituted by a clutch or brake incorporated in a forward/reverse switching device, or a step-variable transmission of a planetary gear type or parallel-axes type having a plurality of different speed ratios and configured to be placed in a power cut-off state (neutral state) for inhibiting power transmission therethrough. A hydraulically operated frictional coupling device are preferably employed as the clutch or brake.

In the motor drive mode recited in claim 1, the vehicle may be driven by only the second electric motor used as the vehicle drive power source while the engine is at rest. However, the vehicle may be driven otherwise in the motor drive mode. For instance, the vehicle may be driven by both of the first and second electric motors used as the vehicle drive power source, or driven by the second electric motor while the first electric motor constituted by a motor/generator is operated by the engine to generate an electric energy. In the engine drive mode, the vehicle is driven by at least the engine used as the vehicle drive power source, with the first or second electric motor being used as needed as an assisting vehicle drive power source. However, the vehicle may be driven otherwise in the engine drive mode. Where the first or second electric motor is constituted by a motor/generator, for example, the vehicle may be driven by the engine while the motor/generator is operated as an electric generator to perform a regenerative operation.

In the second aspect of the invention, a mode selector switch may be provided to permit the vehicle operator to select a power drive mode for driving the vehicle with relatively high power or an economy drive mode for driving the vehicle with relatively high of fuel economy, for example, so that the responsive-oriented motor drive sub-mode is established when the power drive mode is selected by the mode selector switch, and the fuel-economy-oriented motor drive sub-mode is established when the economy drive mode is selected by the mode selector switch. In spite of using the mode selector switch, the manner of driving of the vehicle desired by the vehicle operator can be determined to be a manner of driving the vehicle with relatively high power or not, which is represented by a vehicle accelerating operation or braking operation of the vehicle operator, and the response-oriented motor drive sub-mode is established when the vehicle operator desires a relatively high power driving of the vehicle. Alternatively, the fuel-economy-oriented motor drive sub-mode is established when an electric energy amount SOC stored in an electric-energy storage device (battery) is reduced to a predetermined threshold value SOC1 or less, and the response-oriented motor drive sub-mode is established when the electric energy amount SOC is further reduced below a predetermined threshold value SOC2 below which there is a high possibility of starting the engine. Further alternatively, the fuel-economy-oriented motor drive sub-mode is established when the vehicle running speed is not higher than a threshold value V1 below which a sufficient vehicle drive torque corresponding to an amount of the vehicle accelerating operation can be generated by the second electric motor, and the response-oriented motor drive sub-mode is established for permitting efficient starting of the engine, when the vehicle running speed rises above the threshold value V1 above which the second electric motor cannot generate the sufficient vehicle drive torque as represented by the vehicle accelerating operation. The response-oriented and fuel-economy-oriented motor drive sub-modes may be selectively established in various other manners, for instance, on the basis of vehicle navigation information, or according to any combination of the above-indicated conditions.

In the second aspect of the invention, the motor drive mode is available in a selected one of the two motor-drive sub-modes consisting of the response-oriented motor drive sub-mode established by placing the first connecting/disconnecting device in the power cut-off state and placing the second connecting/disconnecting device in the power transmitting state, and the fuel-economy-oriented motor drive sub-mode established by placing the first connecting/disconnecting device in the power transmitting state and placing the second connecting/disconnecting device in the power cut-off state. However, the first aspect of this invention requires at least the response-oriented motor drive sub-mode. Further, the motor drive mode may be available in a selected one of three motor drive sub-modes consisting of the above-described response-oriented and fuel-economy-oriented motor drive sub-modes, and a third motor drive sub-mode which is established by placing both of the first and second connecting/disconnecting devices in the power cut-off states when there is a low possibility of starting the engine, for example.

The transmission provided according to the third aspect of the invention may be a step-variable transmission of a planetary gear type or a parallel-axes type, or a continuously variable transmission of a belt type. Where such a transmission is provided, the engine has some difficulty of starting in the power transmitting state of the first connecting/disconnecting device. Although the first and second aspects of the invention do not require the provision of such a transmission, the transmission still causes difficult starting of the engine due to an increased inertia upon its starting while the first connecting/disconnecting device is placed in the power transmitting state.

In a preferred form of the invention, there is provided determining means for determining whether a relatively high power highly responsive driving of the vehicle is required by the vehicle operator who has operated drive mode selecting means to select the high power driving. When the determining means determines that the high power driving is required by the vehicle operator, the first connecting/disconnecting device is placed in the power cut-off state and the second connecting/disconnecting device is placed in the power transmitting state, to establish the response-oriented motor drive sub-mode. The above-indicated drive mode selecting means may be sporty drive mode selecting means manually operated to select a sporty drive mode in which the speed ratio (speed position or shift position) of an automatic transmission is changed, or power shifting pattern selecting means manually operated to select a power shifting pattern of a shifting map used to shift the automatic transmission. The determining means determines that the high power driving of the vehicle is required, when the sporty drive mode or the power shifting pattern is selected. The above-described mode selector switch used by the vehicle operator to select a desired one of the power drive mode for high power vehicle driving and the economy drive mode for high fuel economy vehicle driving is equivalent to the power shifting pattern selecting means.

### Embodiment 1

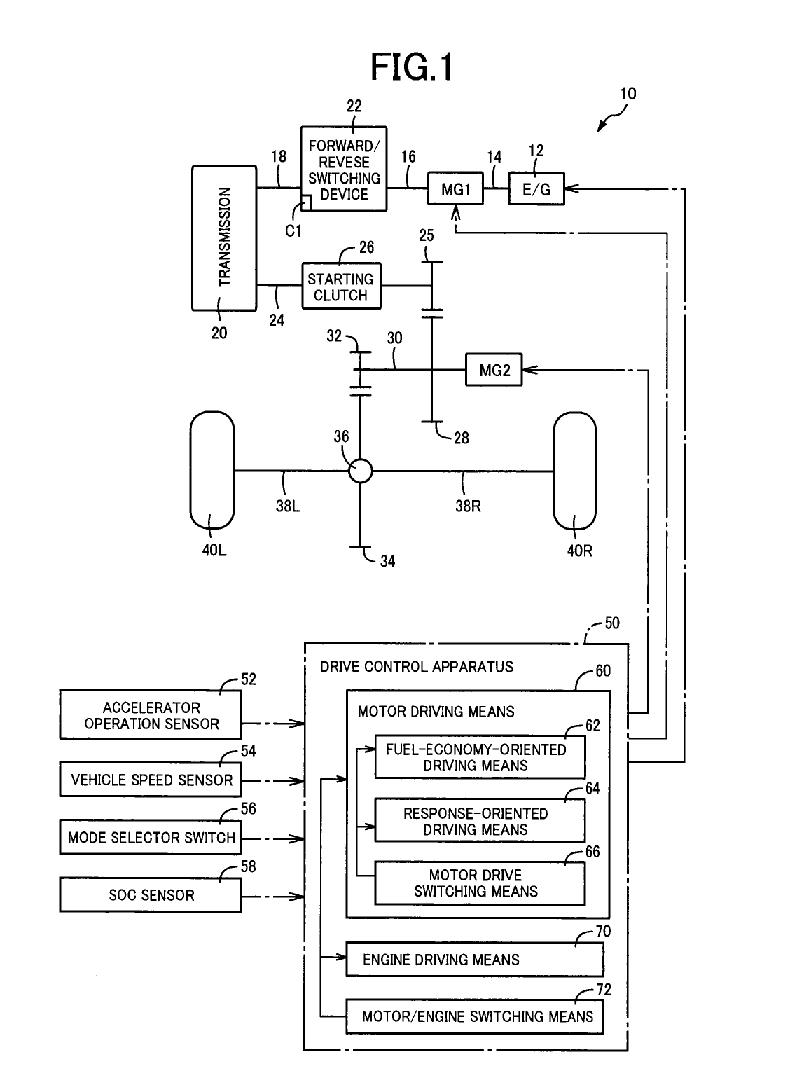

Embodiments of this invention will be described in detail by reference to the drawings. FIG. 1 is the schematic view showing an arrangement of a hybrid drive system 10 of a vehicle according to one embodiment of this invention. The hybrid drive system 10 is provided with: an engine 12; a first motor/generator MG1 connected to a crankshaft 14 of the engine 12; a forward/reverse switching device 22 connected to the first motor/generator MG1 through a intermediate shaft 16 and to a transmission 20 through a input shaft 18; a starting clutch 26 disposed between an output shaft 24 of the transmission 20 and a first gear 25 and configured to permit and inhibit power transmission; a counter shaft 30 on which a second gear 28 meshing with the first gear 25 is mounted; a second motor/generator MG2 connected to the counter shaft 30; a third gear 32 mounted on the counter shaft 30; a differential gear device 36 on which a fourth gear 34 meshing with the third gear 32 is mounted; and left and right front drive wheels 40L and 40R connected to the differential gear device 36 through respective left and right axles 38L and 38R. The engine 12 is an internal combustion engine constructed to produce a drive force by combustion of a fuel, while each of the first motor/generator MG1 and second motor/generator MG2 can be used as electric motors and electric generators. The first motor/generator MG1 is equivalent to a first electric motor, while the second motor/generator MG2 is equivalent to a second electric motor.

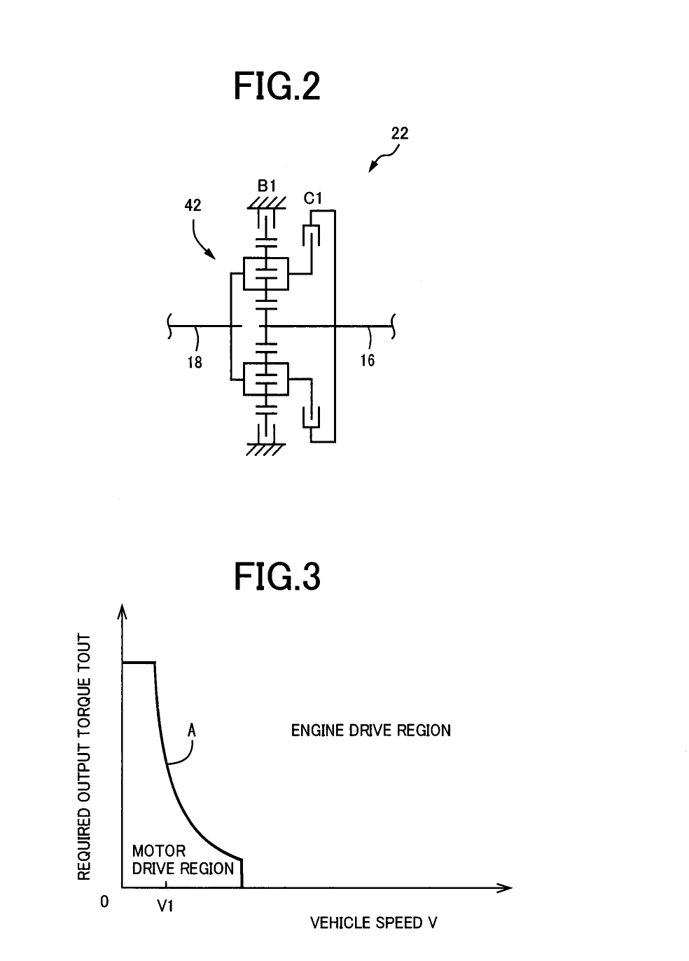

The above-indicated forward/reverse switching device 22 is equivalent to a first connecting/disconnecting device, and is provided with a planetary gear set 42 of a double-pinion type, a forward drive clutch C1, and a reverse drive brake B1 as shown in FIG. 2. Described more specifically, the planetary gear set 42 has a sun gear connected to the above-indicated intermediate shaft 16, a carrier connected to the input shaft 18 and selectively connected to the intermediate shaft 16 through the forward drive clutch C1, and a ring gear selectively fixed through the reverse drive brake B1 such that the ring gear is not rotatable. The forward/reverse switching device 22 is placed in a power cut-off state for inhibiting power transmission between the intermediate shaft 16 and the input shaft 18 when the forward drive clutch C1 and the reverse drive brake B1 are both placed in their released states, in a forward drive state for transmitting a rotary motion of the intermediate shaft 16 to the input shaft 18 when the forward drive clutch C1 is placed in its engaged state while the reverse drive brake B1 is placed in its released state, and in a reverse drive state for transmitting the rotary motion of the intermediate shaft 16 to the input shaft 18 such that a direction of rotation of the input shaft 18 is reversed with respect to that of the intermediate shaft 16 when the forward drive clutch C1 is placed in its released state while the reverse drive brake B1 is placed in its engaged state. The forward drive clutch C1 and reverse drive brake B1 are constituted by hydraulically operated frictional coupling devices, for instance. It is noted that the forward/reverse switching device 22 may have various modifications, such as a modification to use a planetary gear set of a single-pinion type.

In this embodiment, the transmission 20 is a belt type continuously variable transmission having an input pulley and an output pulley. The input pulley is disposed coaxially with the above-described engine 12, first motor/generator MG1 and forward/reverse switching device 22, while the output pulley is disposed coaxially with the above-described starting clutch 26 and first gear 25. The starting clutch 26 is a hydraulically operated frictional coupling device, and is equivalent to a second connecting/disconnecting device configured to permit and inhibit power transmission between the output shaft 24 and the first gear 25.

The vehicular hybrid drive system 10 constructed as described above permits the vehicle to run in a motor drive mode with only the second motor/generator MG2 used as a vehicle drive power source while the engine 12 is at rest, and in an engine drive mode with the engine 12 used as the vehicle drive power source, and is provided with a drive control apparatus 50 configured to implement drive controls relating to the motor drive mode and engine drive mode. The drive control apparatus 50 is provided with a microcomputer, and is configured to perform signal processing operations according to control programs preliminarily stored in a ROM while utilizing a temporary data storage function of a RAM. The drive control apparatus 50 receives an output signal of an accelerator operation sensor 52 indicative of an operation amount θacc of an accelerator pedal, an output signal of a vehicle speed sensor 54 indicative of a running speed V of the vehicle, an output signal of a mode selector switch 56 indicative of a presently selected drive mode, and an output signal of an SOC sensor 58 indicative of an electric energy amount SOC stored in an electric-energy storage device (not shown) provided as an electric power source for the first motor/generator MG1 and second motor/generator MG2. The mode selector switch 56 is disposed on an instrumental panel or a steering wheel of the vehicle, to permit the vehicle operator to select a power drive mode for driving the vehicle with relatively high power, or an economy drive mode for driving the vehicle with relatively high fuel economy. The above-described transmission 20 is controlled to be shifted according to different shifting conditions determined preliminarily, depending upon a selected one of the power and economy drive modes, that is, according to a power drive shifting pattern or an economy drive shifting pattern. According to the power drive shifting pattern, the transmission 20 is shifted such that a target value of the input speed for the same vehicle speed V is relatively high (shifted to a relatively low gear position). According to the economy drive shifting pattern, the transmission 20 is shifted such that the target value of the input speed for the same vehicle speed V is relatively low (shifted to a relatively high gear position). The mode selector switch 56 is equivalent to pattern selecting means (manually operated selecting means). The electric energy amount SOC is obtained by calculating from time to time amounts of charging and discharging of the electric-energy storage device.

The drive control apparatus 50 has functional means in the form of motor driving means 60, engine driving means 70 and motor/engine switching means 72. The motor driving means 60 is configured to establish the motor drive mode in which only the second motor/generator MG2 is used as the vehicle drive power source while the engine 12 is at rest, and the engine driving means 70 is configured to establish the engine drive mode in which the engine 12 is used as the vehicle drive power source. The motor/engine switching means 72 is configured to switch the vehicle drive mode between the motor drive mode and the engine drive mode, according to a drive power source switching map indicated in FIG. 3 by way of example. A required output torque TOUT in FIG. 3 is obtained on the basis of the operation amount θacc of the accelerator pedal, for instance, and the drive power source switching map defines a solid line A defining a motor drive region and an engine drive region such that the motor drive region lies on one of the opposite sides of the solid line A on which the vehicle speed is lower and the required output torque is smaller, and such that the engine drive region lies on the other side of the solid line A on which the vehicle speed is higher and the required output torque is smaller. The motor drive mode is established by the above-described motor driving means 60 when the vehicle running condition falls within the motor drive region, and the engine drive mode is established by the above-described engine driving means 70 when the vehicle running condition falls within the engine drive region. In the engine drive mode, the second motor/generator MG2 is also operated as needed to generate an assisting vehicle drive torque, or the first motor/generator MG1 is operated as the electric generator as needed to charge the electric-energy storage device or to supply an electric energy to the second motor/generator MG2.

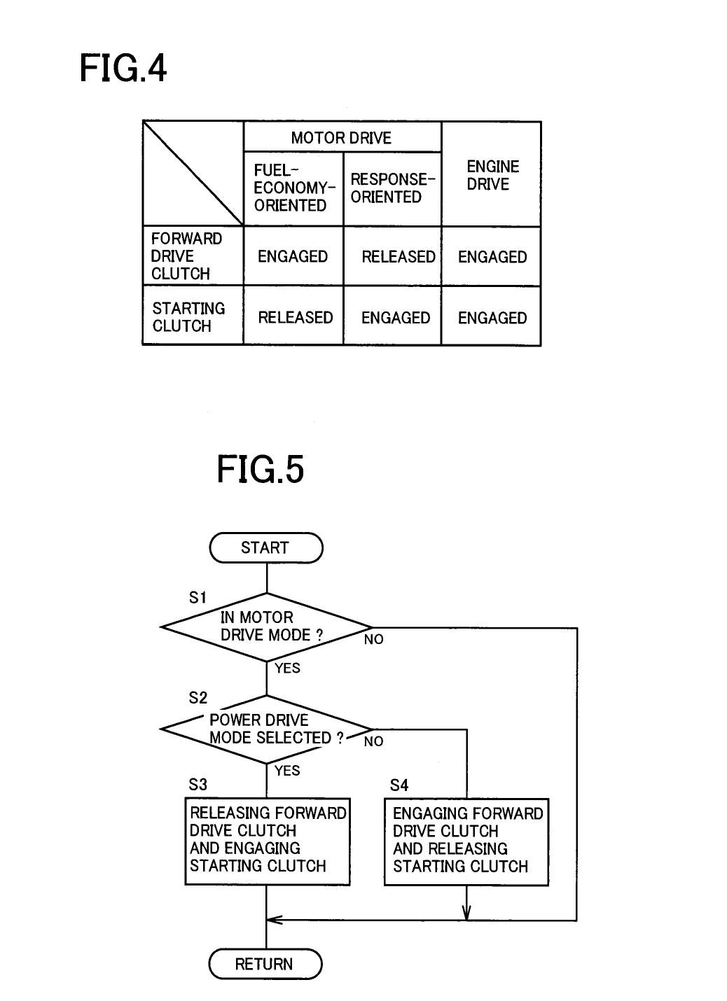

As shown in FIG. 4, the above-described engine drive mode is established by placing both of the above-described forward drive clutch C1 of the above-described forward/reverse switching device 22 and the starting clutch 26 in the engaged states. The above-described motor drive mode is available in selected one of two motor drive sub-modes, that is, a fuel-economy-oriented motor drive sub-mode or a response-oriented motor drive sub-mode. The fuel-economy-oriented motor drive sub-mode is established by placing the forward drive clutch C1 in the engaged state and placing the starting clutch 26 in the released state. The response-oriented motor drive sub-mode is established by placing the forward drive clutch C1 in the released state and placing the starting clutch 26 in the engaged state. The above-indicated motor driving means 60 has functional means in the form of fuel-economy-oriented driving means 62, response-oriented driving means 64, and motor drive switching means 66 as shown in FIG. 1. The fuel-economy-oriented driving means 62 is configured to engage the forward drive clutch C1 and release the starting clutch 26 to establish the fuel-economy-oriented motor drive sub-mode for driving the vehicle with only the second motor/generator MG2 used as the vehicle drive power source. Namely, the starting clutch 26 located close to the second motor/generator MG2 is released to disconnect the transmission 20 from the second motor/generator MG2, for minimizing the number of rotary members having dragging rotary motions in the motor drive mode, to reduce the power loss (the load acting on the electric motor MG2), for thereby improving the fuel economy. When the engine 12 is cranked by the first motor/generator MG1 to change the vehicle drive mode from the fuel-economy-oriented motor drive sub-mode to the engine drive mode, the input pulley and output pulley of the transmission 20 are rotated with the engine 12 in the engaged state of the forward drive clutch C1, with a result of an increase of an inertia, which causes comparatively difficult starting of the engine 12. After the engine 12 has been started, however, the engaging action of only the starting clutch 26 is required, and the control for this engaging action (by the hydraulic control) can be implemented easily and efficiently. The above-described engaging action of the forward drive clutch C1 is equivalent to the power transmitting state of the first connecting/disconnecting device, while the above-described releasing action of the starting clutch 26 is equivalent to the power cut-off state of the second connecting/disconnecting device.

The response-oriented driving means 64 is configured to establish the response-oriented motor drive sub-mode for driving the vehicle with only the second motor/generator MG2 used as the vehicle drive power source, by releasing the forward drive clutch C1 and engaging the starting clutch 26. Namely, the forward drive clutch C1 of the forward/reverse switching device 22 located close to the engine 12 is released to disconnect the transmission 20 from the engine 12, for reducing an inertia upon cranking of the engine 12 by the first motor/generator MG1, improving the ease and efficiency of starting of the engine 12 to change the vehicle drive mode from the motor drive mode to the engine drive mode. In addition, the starting clutch 26 is already placed in the engaged state in the motor drive mode, so that the engaging action of only the forward drive clutch C1 is required, and the control for this engaging action (by the hydraulic control) can be implemented easily and efficiently. Accordingly, the response to a vehicle accelerating operation by the vehicle operator is improved, permitting the engine 12 to provide a comparatively large vehicle drive force in an efficient manner upon changing of the vehicle drive mode from the motor drive mode to the engine drive mode. However, the starting clutch 26 already placed in the engaged state in the motor drive mode causes dragging of the output pulley and input pulley of the transmission 20, resulting in an increase of the power loss and deterioration of the fuel economy. The above-described releasing action of the forward drive clutch C1 is equivalent to the power cut-off state of the first connecting/disconnecting device, while the above-described engaged state of the starting clutch 26 is equivalent to the power transmitting state of the second connecting/disconnecting device.

The above-described motor drive switching means 66 is configured to perform a signal processing operation according to the flow chart of FIG. 5, in the present embodiment, for selectively establishing the fuel-economy-oriented motor drive sub-mode or the response-oriented motor drive sub-mode according to a mode which is selected by the mode selector switch 56. Step S2 in FIG. 5 corresponds to the motor drive switching means 66, and step S3 corresponds to the response-oriented driving means 64, while step S4 corresponds to the fuel-economy-oriented driving means 62.

A control operation of the flow chart of FIG. 5 is performed when any forward drive position such as a “D” position for driving the vehicle in the forward direction is selected. Step S1 is implemented to determine whether the motor drive mode is selected by the above-described motor/engine switching means 72. If the motor drive mode is selected, the control flow goes to step S2 to determine whether the power drive mode is selected by the mode selector switch 56. If the power drive mode is selected, it is determined that the vehicle operator desires a relatively high power driving of the vehicle, and the control flow goes to step S3 to place the forward drive clutch C1 in the released state and place the starting clutch 26 in the engaged state, for establishing the response-oriented motor drive sub-mode. If the economy mode is selected, the control flow goes to step S4 to place the forward drive clutch C1 in the engaged state and place the starting clutch 26 in the released state, for establishing the fuel-economy-oriented motor drive sub-mode. The motor drive switching means 66 configured to implement the above-described step S2 is equivalent to determining means for determining whether the relatively high power driving of the vehicle is required by the mode selector switch 56, namely, whether the power drive mode is selected by the mode selector switch 56.

The vehicular hybrid drive system 10 according to the present embodiment described above is configured such that the response-oriented motor drive sub-mode is established by the response-oriented driving means 64 by placing the forward drive clutch C1 in the released state and placing the starting clutch 26 in the engaged state, when the power drive mode is selected by the mode selector switch 56. In the response-oriented motor drive sub-mode in which the engine 12 and the transmission 20 are disconnected from each other, the engine 12 can be efficiently started by cranking by the first motor/generator MG1 to change the vehicle drive mode from the motor drive mode to the engine drive mode. After the engine 12 has been started, the engaging action of only the forward drive clutch C1 is required, and the control for this engaging action can be implemented easily and efficiently. Accordingly, the response to the vehicle accelerating operation by the vehicle operator is improved, permitting the engine 12 to provide a comparatively large vehicle drive force in an efficient manner upon changing of the vehicle drive mode from the motor drive mode to the engine drive mode. Thus, the vehicle operator who desires a powerful driving of the vehicle with a high response to the vehicle accelerating operation can be satisfied to an increased extent with the vehicle running in the power drive mode.

The present embodiment is further configured to provide the two motor drive sub-modes consisting of the response-oriented motor drive sub-mode established by placing the forward drive clutch C1 in the released state and placing the starting clutch 26 in the engaged state, and the fuel-economy-oriented motor drive sub-mode established by placing the forward drive clutch C1 in the engaged state and placing the starting clutch 26 in the released state. The response-oriented motor drive sub-mode is established when the vehicle operator selects the power drive mode, while the fuel-economy-oriented motor drive sub-mode is established when the vehicle operator selects the economy drive mode. Accordingly, the response is improved upon changing of the vehicle drive mode to the engine drive mode from the motor drive mode during the power drive mode is selected, and the deterioration of the fuel economy is minimized by establishing the fuel-economy-oriented motor drive sub-mode when the economy drive mode is selected.

The present embodiment wherein the transmission 20 is disposed in the power transmitting path between the forward/reverse switching device 22 and the starting clutch 26 is also configured to place the forward drive clutch C1 of the forward/reverse switching device 22 in the released state in the motor drive mode, to disconnect the transmission 20 from the engine 12, for considerably reducing an inertia upon cranking of the engine 12 by the first motor/generator MG1, making it possible to considerably improve the ease of starting of the engine 12, and considerably improve the vehicle response upon changing of the vehicle drive mode from the motor drive mode to the engine drive mode.

### Embodiment 2

Other embodiments of this invention will be described. It is noted that the same reference signs as used in the preceding embodiment will be used to identify substantially the same elements, which will not be described in detail.

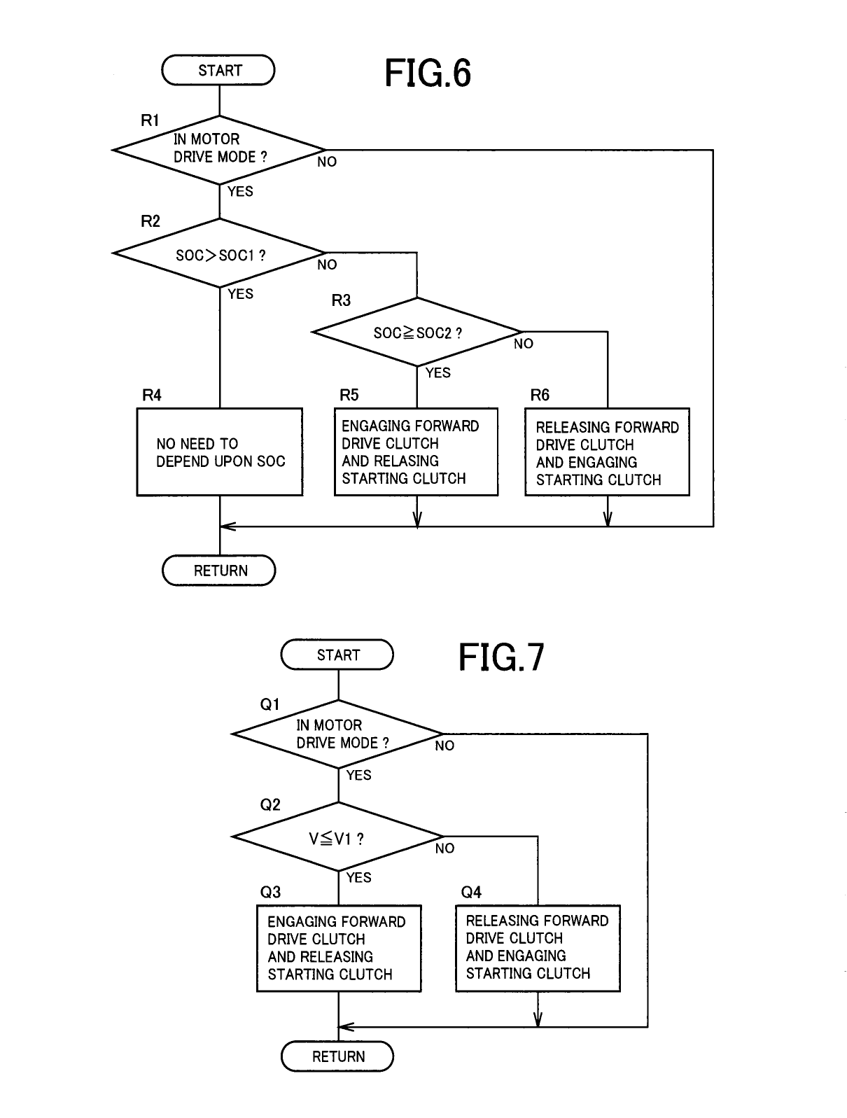

FIG. 6 is the flow chart illustrating a signal processing operation performed by the above-described motor drive switching means 66 according to another embodiment of the invention, in place of that of FIG. 5, to selectively establish the fuel-economy-oriented motor drive sub-mode or the response-oriented motor drive sub-mode, depending upon the electric energy amount SOC stored in the electric-energy storage device. Steps R2 and R3 of FIG. 6 correspond to the motor drive switching means 66, and step R5 corresponds to the fuel-economy-oriented driving means 62, while step R6 corresponds to the response-oriented driving means 64.

The operation of the flow chart of FIG. 6 is performed when any forward drive position is selected. Step R1 is implemented to determine whether the motor drive mode is selected by the above-described motor/engine switching means 72. If the motor drive mode is selected, the control flow goes to step R2 to determine whether the electric energy amount SOC detected by the SOC sensor 58 is larger than a predetermined first threshold value SOC1. The first threshold value SOC1 is a value of the electric energy amount SOC below which it is required to save the fuel consumption, due to reduction of the electric energy amount SOC usable for operating the first motor/generator MG1 and second motor/generator MG2. Therefore, if the electric energy amount SOC is larger than the first threshold value SOC1, that is, if the electric energy amount SOC is sufficient, it is not necessary to save the fuel consumption, and the control flow goes to step R4 in which the electric energy amount SOC is not used to select the motor drive sub-mode. In this case, the signal processing operation is terminated with the step R4. That is, it is not necessary to establish one of the fuel-economy-oriented motor drive mode and the response-oriented motor drive sub-mode, based on the electric energy amount SOC, so that the fuel-economy-oriented motor drive sub-mode or the response-oriented motor drive sub-mode is established in the step R4, depending upon any condition other than the electric energy amount SOC, for instance, whether the power drive mode is selected or not by the above-described mode selector switch 56.

If a negative determination NO is obtained in the step R2, the control flow goes to step R3 to determine whether the electric energy amount SOC is equal to or larger than a predetermined second threshold value SOC2, namely, whether SOC falls in a range of SOC1≧SOC≧SOC2. The second threshold value SOC2 is a value of the electric energy amount SOC below which there is a high possibility of starting the engine 12 to change the vehicle drive mode to the engine drive mode or a high possibility of charging the electric-energy storage device, due to the reduction of the electric energy amount SOC usable for operating the first motor/generator MG1 and second motor/generator MG2. If an affirmative determination YES is obtained in the step R3, that is, if SOC1≧SOC≧SOC2, the control flow goes to step R5 to place the forward drive clutch C1 in the engaged state and place the starting clutch 26 in the released state, to establish the fuel-economy-oriented motor drive sub-mode, so that the fuel consumption (amount of consumption of the electric energy amount stored in the electric-energy storage device) can be saved to increase the distance of running of the vehicle in the motor drive mode. If a negative determination NO is obtained in the step R3, that is, SOC2>SOC, the control flow goes to step R6 to place the forward drive clutch C1 in the released state and place the starting clutch 26 in the engaged state, to establish the response-oriented motor drive sub-mode, so that the response upon starting of the engine 12 is improved, permitting an efficient change of the vehicle drive mode from the motor drive mode to the engine drive mode.

The present embodiment is also configured such that the response-oriented motor drive sub-mode is established by the response-oriented driving means 64 by placing the forward drive clutch C1 in the released state and placing the starting clutch 26 in the engaged state, when there is a high possibility of a change of the vehicle drive mode from the motor drive mode to the engine drive mode as a result of reduction of the electric energy amount SOC in the electric-energy storage device below the second threshold value SOC2. In the response-oriented motor drive sub-mode in which the engine 12 and the transmission 20 are disconnected from each other, the engine 12 can be efficiently started by cranking by the first motor/generator MG1 to change the vehicle drive mode from the motor drive mode to the engine drive mode. After the engine 12 has been started, the engaging action of only the forward drive clutch C1 is required, and the control for this engaging action can be implemented easily and efficiently. Accordingly, the response is improved, permitting the engine 12 to provide a comparatively large vehicle drive force in an efficient manner upon changing of the vehicle drive mode from the motor drive mode to the engine drive mode.

The present embodiment is further configured to provide the two motor drive sub-modes consisting of the response-oriented motor drive sub-mode established by placing the forward drive clutch C1 in the released state and placing the starting clutch 26 in the engaged state, and the fuel-economy-oriented motor drive sub-mode established by placing the forward drive clutch C1 in the engaged state and placing the starting clutch 26 in the released state. The response-oriented motor drive sub-mode is established when the electric energy amount SOC stored in the electric-energy storage device is reduced below the second threshold value SOC2, and the fuel-economy-oriented motor drive sub-mode is established when the electric energy amount SOC is relatively low, that is, SOC is in a range between SOC1 and SOC2 (SOC1>SOC>SOC2). Thus, the present embodiment prevents deterioration of the fuel economy, while assuring an improvement of the response upon starting of the engine when SOC2>SOC, that is, when there is a high possibility of a change of the vehicle drive mode to the engine drive mode.

It is noted that the present second embodiment may be combined with the above-described first embodiment.

### Embodiment 3

FIG. 7 is the flow chart illustrating a signal processing operation performed by the above-described motor drive switching means 66 according to a further embodiment of the invention, in place of that of FIG. 5, to selectively establish the fuel-economy-oriented motor drive sub-mode or the response-oriented motor drive sub-mode, depending upon the vehicle running speed V. Steps Q2 of FIG. 7 corresponds to the motor drive switching means 66, and step Q3 corresponds to the fuel-economy-oriented driving means 62, while step Q4 corresponds to the response-oriented driving means 64.

The operation of the flow chart of FIG. 7 is performed when any forward drive position is selected. Step Q1 is implemented to determine whether the motor drive mode (forward drive mode) is selected by the above-described motor/engine switching means 72. If the motor drive mode is selected, the control flow goes to step Q2 to determine whether the vehicle running speed V detected by the vehicle speed sensor 54 is equal to or lower than a predetermined threshold value V1. The threshold value V1 is an upper limit of the vehicle running speed V below which a torque large enough to deal with the vehicle accelerating operation by the vehicle operator is obtained by the second motor/generator MG2, as shown in FIG. 3, so that there is a low possibility of a change of the vehicle drive mode to the engine drive mode immediately. If V≦V1, the control flow goes to step Q3 to place the forward drive clutch C1 in the engaged state and place the starting clutch 26 in the released state, to establish the fuel-economy-oriented motor drive sub-mode. If a negative determination NO is obtained in the step Q2, that is, if V1<V, the control flow goes to step Q4 to place the forward drive clutch C1 in the released state and place the starting clutch 26 in the engaged state, to establish the response-oriented motor drive sub-mode. Thus, the present embodiment improves the response upon starting of the engine 12, and permits an efficient change of the vehicle drive mode from the motor drive mode to the engine drive mode.

The present embodiment is also configured such that the response-oriented motor drive sub-mode is established by the response-oriented driving means 64 by placing the forward drive clutch C1 in the released state and placing the starting clutch 26 in the engaged state, when there is a high possibility of a change of the vehicle drive mode from the motor drive mode to the engine drive mode as a result of an increase of the vehicle running speed V above the threshold value V1. In the response-oriented motor drive sub-mode in which the engine 12 and the transmission 20 are disconnected from each other, the engine 12 can be efficiently started by cranking by the first motor/generator MG1 to change the vehicle drive mode from the motor drive mode to the engine drive mode. After the engine 12 has been started, the engaging action of only the forward drive clutch C1 is required, and the control for this engaging action can be implemented easily and efficiently. Accordingly, the response is improved, permitting the engine 12 to provide a comparatively large vehicle drive force in an efficient manner upon changing of the vehicle drive mode from the motor drive mode to the engine drive mode.

The present embodiment is further configured to provide the two motor drive sub-modes consisting of the response-oriented motor drive sub-mode established by placing the forward drive clutch C1 in the released state and placing the starting clutch 26 in the engaged state, and the fuel-economy-oriented motor drive sub-mode established by placing the forward drive clutch C1 in the engaged state and placing the starting clutch 26 in the released state. The response-oriented motor drive sub-mode is established when the vehicle running speed V is higher than the threshold value V1, and the fuel-economy-oriented motor drive sub-mode is established when the vehicle running speed V is equal to or lower than the threshold value V1 and when there is a low possibility of a change of the vehicle drive mode to the engine drive mode. Thus, the present embodiment prevents deterioration of the fuel economy, while assuring an improvement of the response upon changing of the vehicle drive mode from the motor drive mode to the engine drive mode.

In the present embodiment, both of the forward drive clutch C1 and the starting clutch 26 may be placed in the released state to establish in the step Q3 the fuel-economy-oriented motor drive sub-mode in which there is substantially no possibility of a change of the vehicle drive mode to the engine drive mode. In this case, only the engaging action of the starting clutch 26 is required to change the vehicle drive mode to the response-oriented motor drive sub-mode in the step Q4 as a result of a rise of the vehicle running speed V above the threshold value V1, so that the control to change the vehicle drive mode to the response-oriented motor drive sub-mode can be easily implemented.

It is noted that the present third embodiment may be combined with the above-described first embodiment and/or the above-described second embodiment.

### Embodiment 4

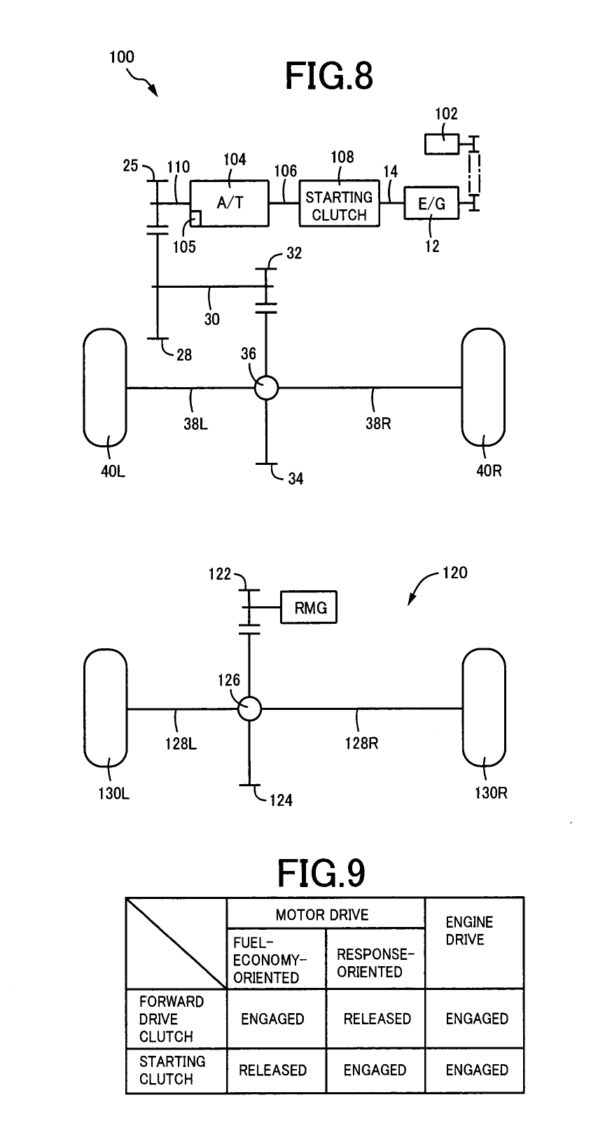

FIG. 8 is the schematic view showing another arrangement of a vehicular hybrid drive system to which the present invention is applicable. This vehicular hybrid drive system 100 is configured to crank the engine 12 by a starter motor 102 connected to the crankshaft 14 through a belt, for instance, and is provided with a step-variable automatic transmission 104 of a planetary gear type, for example, which has a plurality of speed positions to be selectively established by respective combinations of engaging and releasing actions of a plurality of clutches and brakes. Between an input shaft 106 of the automatic transmission 104 and the crankshaft 14, there is disposed a starting clutch 108 configured to permit and inhibit power transmission between the input shaft 106 and the crankshaft 14. The starter motor 102 corresponds to the first electric motor, and is constituted by a motor/generator which also has a function of an electric generator. The automatic transmission 104 can be placed in a neutral state for inhibiting power transmission therethrough, by placing the forward drive clutch 105 in the released state during forward running of the vehicle, and can be operated to transmit a rotary motion with a selected one of speed ratios while the forward drive clutch 105 is placed in the engaged state. In the present embodiment, the starting clutch 108 corresponds to the first connecting/disconnecting device and the automatic transmission 104 corresponds to the second connecting/disconnecting device. The above-described first gear 25 is mounted on an output shaft 110 of the automatic transmission 104, and a vehicle drive force is transmitted from the first gear 25 to the above-described front drive wheels 40L and 40R. The above-described second motor/generator MG2 is not provided in the present embodiment.

On the other hand, the present vehicular hybrid drive system 100 is provided with a rear-wheel drive device 120 in which a rotary motion of a rear drive motor/generator RMG is transmitted to a differential gear device 126 through a fifth gear 122 and a sixth gear 124, so that rear left and right drive wheels 130L and 130R are rotated by rotary motions of the differential gear device 126 through left and right axles 128L and 128R. The rear drive motor/generator RMG corresponds to the second electric motor.

Like the vehicular hybrid drive system 10 of the above-described first embodiment, the present vehicular hybrid drive system 100 is provided with the drive control apparatus 50, and the motor driving means 60 is configured to establish the motor drive mode for driving the vehicle with the rear drive wheels 130L, 130R being rotated by only the rear drive motor/generator RMG used as the vehicle drive power source while the engine 12 is at rest. The engine drive means 62 is configured to establish the engine drive mode for driving the vehicle with the front drive wheels 40L, 40R being rotated by the engine 12 used as the vehicle drive power source. In the engine drive mode, the rear drive motor/generator RMG is also operated to drive the rear drive wheels 130L, 130R, for driving the vehicle in a 4-wheel drive mode as needed. The motor/engine switching means 72 is configured to switch the vehicle drive mode between the motor drive mode and the engine drive mode according to the drive power source switching map indicated in FIG. 3 by way of example in the same manner as the above-described first embodiment.

As indicated in FIG. 9, the engine drive mode is established by placing both of the starting clutch 108 and the forward drive clutch 105 of the automatic transmission 104 in the engaged states. The above-described motor drive mode is available in one of two motor drive sub-modes, that is, a fuel-economy-oriented motor drive sub-mode or a response-oriented motor drive sub-mode. The fuel-economy-oriented motor drive sub-mode is established by placing the starting clutch 108 in the engaged state and placing the forward drive clutch 105 in the released state. The response-oriented motor drive sub-mode is established by placing the starting clutch 108 in the released state and placing the forward drive clutch 105 in the engaged state. Namely, the fuel-economy-oriented driving means 62 engages the starting clutch 108 and releases the forward drive clutch 105 to establish the fuel-economy-oriented motor drive sub-mode for driving the vehicle with the rear drive wheels rotated by only the rear drive motor/generator RMG used as the vehicle drive power source. The forward drive clutch 105 of the automatic transmission 104 located close to the front drive wheels 40L, 40R is released for minimizing the number of rotary members having dragging rotary motions in the motor drive mode, to reduce the power loss for thereby improving the fuel economy. When the engine 12 is cranked by the starter motor 102 to change the vehicle drive mode from the fuel-economy-oriented motor drive sub-mode to the engine drive mode, some of the rotary members of the automatic transmission 104 are rotated with the engine 12 in the engaged state of the starting clutch 108, with a result of an increase of an inertia, which causes comparatively difficult starting of the engine 12. After the engine 12 has been started, however, the engaging action of only the forward drive clutch 105 is required, and the control for this engaging action (by the hydraulic control) can be implemented easily and efficiently. The above-described engaging action of the starting clutch 108 is equivalent to the power transmitting state of the first connecting/disconnecting device, while the above-described releasing action of the forward drive clutch 105 is equivalent to the power cut-off state of the second connecting/disconnecting device.

The response-oriented driving means 64 releases the starting clutch 108 and engages the forward drive clutch 105 to establish the response-oriented motor drive sub-mode for driving the vehicle with the rear drive wheels rotated by only the rear drive motor/generator RMG used as the vehicle drive power source. The starting clutch 108 located close to the engine 12 is released to disconnect the automatic transmission 104 from the engine 12, for reducing an inertia upon cranking of the engine 12 by the starter motor 102, improving the ease and efficiency of starting of the engine 12 to change the vehicle drive mode from the motor drive mode to the engine drive mode. In addition, the forward drive clutch 105 is already placed in the engaged state in the motor drive mode, so that the engaging action of only the starting clutch 108 is required, and the control for this engaging action (by the hydraulic control) can be implemented easily and efficiently. Accordingly, the response to a vehicle accelerating operation by the vehicle operator is improved, permitting the engine 12 to provide a comparatively large vehicle drive force in an efficient manner upon changing of the vehicle drive mode from the motor drive mode to the engine drive mode. However, the forward drive clutch 105 already placed in the engaged state in the motor drive mode causes dragging rotary motions of the automatic transmission 104, resulting in an increase of the power loss and deterioration of the fuel economy. The above-described releasing action of the starting clutch 108 is equivalent to the power cut-off state of the first connecting/disconnecting device, while the above-described engaged state of the forward drive clutch 105 is equivalent to the power transmitting state of the second connecting/disconnecting device.

The above-described motor drive switching means 66 selectively establishes the fuel-economy-oriented motor drive sub-mode or the response-oriented motor drive sub-mode, on the basis of the drive mode selected by the mode selector switch 56, the electric energy amount SOC stored in the electric-energy storage device, or the vehicle running speed V, as in the first through third embodiments. Thus, the present embodiment has the same advantages as the above-described first through third embodiments.

### Embodiment 5

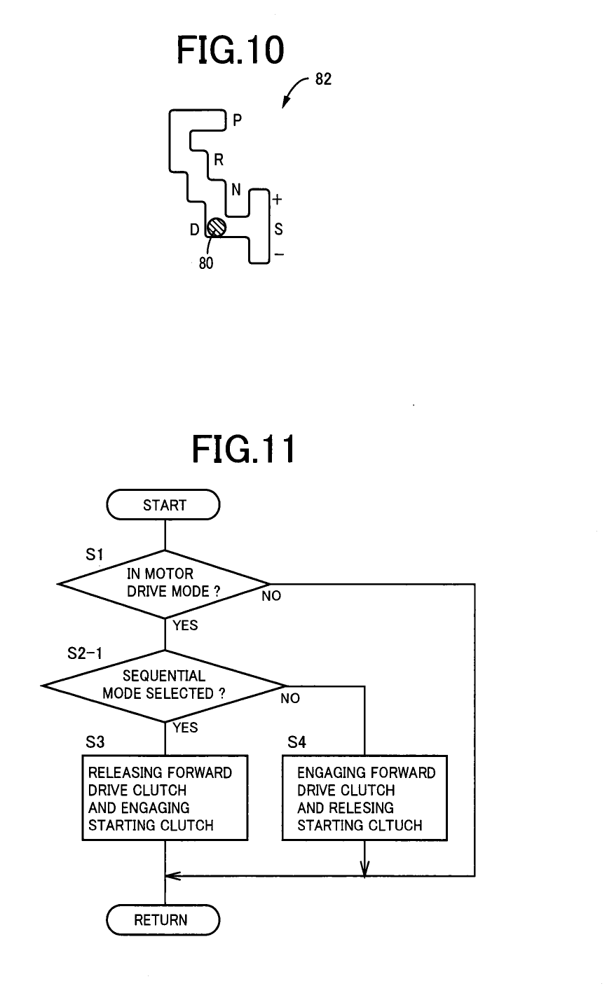

FIG. 10 is the view showing a shifting pattern 82 in the embodiment of FIG. 1. A shift lever 80 disposed near the vehicle operator's seat has five operating positions “P”, “R”, “N”, “D” and “S”. The operating position “P” is a parking position for placing the hybrid drive system in a neutral state for inhibiting power transmission therethrough by releasing both of the forward drive clutch C1 and the reverse drive brake B1 of the forward/reverse switching device 22, and for mechanically preventing rotation of (locking) the counter shaft 30 by a mechanical parking mechanism. The operating position “R” is a reverse drive position for backward driving of the vehicle with the reverse drive brake B1 of the forward/reverse switching device 22 placed in the engaged state. The operating position “N” is a neutral position for placing the hybrid drive system in a neutral state for inhibiting power transmission therethrough by releasing both of the forward drive clutch C1 and the reverse drive brake B1 of the forward/reverse switching device 22. The operating position “D” is a forward drive position for forward driving of the vehicle with the forward drive clutch C1 of the forward/reverse switching device 22 placed in the engaged state. In this forward drive position, the speed ratio (target input speed, for instance) of the transmission 20 is automatically continuously changed according to a predetermined shifting conditions on the basis of the operation amount θacc of the accelerator pedal, vehicle running speed V, etc.

The operating position “S” is a forward drive position for establishing a sequential mode in which the speed ratio is changed in steps by a manual operation of the shift lever 80. The shift lever 80 has a shift-up position “+” and a shift-down position “−” on respective front and rear sides of the operating position “S”. The speed ratio is changed in a shift-up direction each time the shift lever 80 is operated to the shift-up position “+”, and in a shift-down direction each time the shift lever 80 is operated to the shift-down position “−”. Each of the shift-up position “+” and the shift-down position “−” is unstable and the shift lever 80 is biased by suitable biasing means such as a spring so that the shift lever 80 is automatically returned back to the operating position “S” after each operation to the shift-up position “+” or shift-down position “−”. The speed ratio is changed according to the number of operations of the shift lever 80 to the shift-up position “+” or shift-down position “−”, or a length of time for which the shift lever 80 is held at the shift-up position “+” or shift-down position “−”. The above-described sequential mode is equivalent to a sporty drive mode in which the speed ratio can be manually changed, and the shift lever 80 corresponds to sporty drive mode selecting means (manually selecting means).

Where the sequential mode described above is available, the above-described motor drive switching means 66 may be configured to switch the motor drive mode between the response-oriented motor drive sub-mode and the fuel-economy-oriented motor drive sub-mode, depending upon whether the sequential mode is selected or not, as indicated in the flow chart of FIG. 11. The operation illustrated in the flow chart of FIG. 11 is performed in place of that of FIG. 5. Step S2-1 is implemented to determine whether the sequential mode is selected or not, more specifically, whether the shift lever 80 is placed in the operating position “S” or not. If the sequential mode is selected, it is determined that the vehicle operator desires powerful highly responsive driving of the vehicle, and the control flow goes to S3 to place the forward drive clutch C1 in the released state and place the starting clutch 26 in the engaged state, for establishing the response-oriented motor drive sub-mode. If the sequential mode is not selected, that is if the shift lever 80 is placed in the normal-drive operating position “D”, the control flow goes to step S4 to place the forward drive clutch in the engaged state and place the starting clutch 26 in the released state, for establishing the fuel-economy-oriented motor drive sub-mode. The motor drive switching means 66 which implements the above-indicated step S2-1 corresponds to determining means for determining whether the powerful highly responsive driving of the vehicle is selected by operation of the shift lever 80. An affirmative determination that the powerful highly responsive driving of the vehicle is selected is made when the sequential mode is selected.

The present embodiment has the same advantages as the above-described first embodiment.

The present fifth embodiment may be combined with any one or all of the first through third embodiments, and may be applicable to the vehicular hybrid drive system 100 shown in FIG. 8.

While the embodiments of this invention have been described in detail by reference to the drawings, for illustrative purpose only, it is to be understood that the invention may be made with various changes and improvements, which may occur to those skilled in the art.
10, 100: Vehicular hybrid drive system
12: Engine
20: Transmission
22: Forward/reverse switching device (First connecting/disconnecting device)
26: Starting clutch (Second connecting/disconnecting device)
50: Drive control apparatus
62: Fuel-economy-oriented driving means
64: Response-oriented driving means
66: Motor drive switching means
102: Starter motor (First electric moor)
104: Automatic transmission (Second connecting/disconnecting device)
108: Starting clutch (First connecting/disconnecting device)
MG1: First motor/generator (First electric motor)
MG2: Second motor/generator (Second electric moor)
RMG: Reverse-drive motor/generator (Second electric motor)

1-4. (canceled)

5. A hybrid drive system of a vehicle, including (a) an engine, (b) a first electric motor connected to the engine, (c) a first connecting/disconnecting device configured to permit and inhibit power transmission between said engine and said first electric motor, and drive wheels of the vehicle, (d) a second connecting/disconnecting device configured to permit and inhibit power transmission between said first connecting/disconnecting device and said drive wheels, and (e) a second electric motor enabling the vehicle to run while said engine is at rest, and the hybrid drive system permitting the vehicle to run in a motor drive mode with an operation of said second electric motor while said engine is at rest, and in an engine drive mode with an operation of said engine,
said motor drive mode being available in a selected one of a first EV mode established by placing said first connecting/disconnecting device in a power cut-off state and placing said second connecting/disconnecting device in a power transmitting state, and a second EV mode established by at least placing said second connecting/disconnecting device in a power cut-off state.

6. The hybrid drive system according to claim 5, wherein said second EV mode is established by placing said first connecting/disconnecting device in a power transmitting state and placing said second connecting/disconnecting device in the power cut-off state.

7. The hybrid drive system according to claim 5, wherein a transmission is disposed in a power transmitting path between said first connecting/disconnecting device and said second connecting/disconnecting device.

8. The hybrid drive system according to claim 5, wherein said second connecting/disconnecting device is a transmission which is switchable between a power transmitting state for permitting the power transmission with a predetermined speed ratio, and a power cut-off state for inhibiting said power transmission with the predetermined speed ratio.
